(19) United States
(12) Patent Application Publication
(10) Pub. No.: US 2005/0205380 A1
(43) Pub. Date: Sep. 22, 2005

(54) Retaining ring apparatus for a hybrid transmission

(76) Inventor: James A. Raszkowski, Indianapolis, IN (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 11/060,077

(22) Filed: Feb. 17, 2005

Related U.S. Application Data
(60) Provisional application No. 60/555,141, filed on Mar. 22, 2004.

(51) Int. Cl. F16D 13/52

(52) U.S. Cl. 192/106 F; 192/85 AA

(57) ABSTRACT

A clutch assembly of the present invention includes a clutch housing having a plurality of housing splines. A plurality of clutch plates are disposed within the housing splines. The clutch assembly further includes a clutch hub having a plurality of hub splines. A plurality of friction plates are disposed within the hub splines and are interposed between the plurality of clutch plates. An apply piston is adapted to engage the clutch plates and the friction plates. The clutch assembly also includes a balance piston having a shoulder portion. A retaining ring is disposed in a retainer groove defined by a rotating shaft. The retaining ring is adapted to engage the balance piston such that the retaining ring is radially retained by the shoulder portion and the retaining ring therefore cannot expand and slip out of the retainer groove. A return spring is preferably disposed between the apply piston and the balance piston. The return spring is adapted to axially bias the balance piston into engagement with the retaining ring to maintain the engagement of the retaining ring by the shoulder portion.

### CROSS-REFERENCE TO RELATED APPLICATIONS

This application claims the benefit of U.S. Provisional Application No. 60/555,141, filed Mar. 22, 2004, which is hereby incorporated by reference in its entirety.

### TECHNICAL FIELD

This invention relates to retaining rings and, more particularly, to external retaining rings disposed in a groove in a transmission shaft.

### BACKGROUND OF THE INVENTION

Many mechanical devices employ at least one rotating shaft in which a rotating or retaining ring is disposed. The purpose of the retaining ring is to limit the movement of at least one mechanical member in a given direction, thereby setting the limits of assembly movement for that particular component.

One of the problems facing external retaining rings is that of centrifugal force. As the shaft in which the retaining ring is disposed rotates at high speed, the ring itself has a tendency to expand and thereby become loosened within the groove and perhaps even be expelled from the groove.

### SUMMARY OF THE INVENTION

The present invention provides an apparatus for securing a retaining ring within a retention groove in the presence of high centrifugal forces.

A clutch assembly of the present invention includes a clutch housing having a plurality of housing splines. A plurality of clutch plates are disposed within the housing splines. The clutch assembly further includes a clutch hub having a plurality of hub splines. A plurality of friction plates are disposed within the hub splines and are interposed between the plurality of clutch plates. An apply piston is adapted to engage the clutch plates and the friction plates. The clutch assembly also includes a balance piston having a shoulder portion. A retaining ring is disposed in a retainer groove defined by a rotating shaft. The retaining ring is adapted to engage the balance piston such that the retaining ring is radially retained by the shoulder portion and the retaining ring therefore cannot expand and slip out of the retainer groove. A return spring is preferably disposed between the apply piston and the balance piston. The return spring is adapted to axially bias the balance piston into engagement with the retaining ring to maintain the engagement of the retaining ring by the shoulder portion.

In one aspect of the present invention, the shoulder portion of the balance piston includes a single feature adapted to retain the entire periphery of the retaining ring.

In another aspect of the present invention, the shoulder portion of the balance piston includes a plurality of localized tabs adapted to retain the periphery of the retaining ring at discrete locations.

In yet another aspect of the present invention, the shoulder portion of the balance piston is created by a semi-pierce operation.

In a further aspect of the present invention, the shoulder portion of the balance piston is created by a forming operation.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic fragmentary cross-sectional view of a hybrid electromechanical transmission consistent with the present invention;

FIG. 2A is a schematic fragmentary cross-sectional view of a first clutch assembly of the transmission of FIG. 1;

FIG. 2B is a front view of a balance piston according to a preferred embodiment of the clutch assembly of FIG. 2A;

FIG. 2C is a front view of a balance piston according to an alternate embodiment of the clutch assembly of FIG. 2A; and

FIG. 3 is a schematic fragmentary cross-sectional view of a second clutch assembly of the transmission of FIG. 1.

### DESCRIPTION OF THE PREFERRED EMBODIMENTS

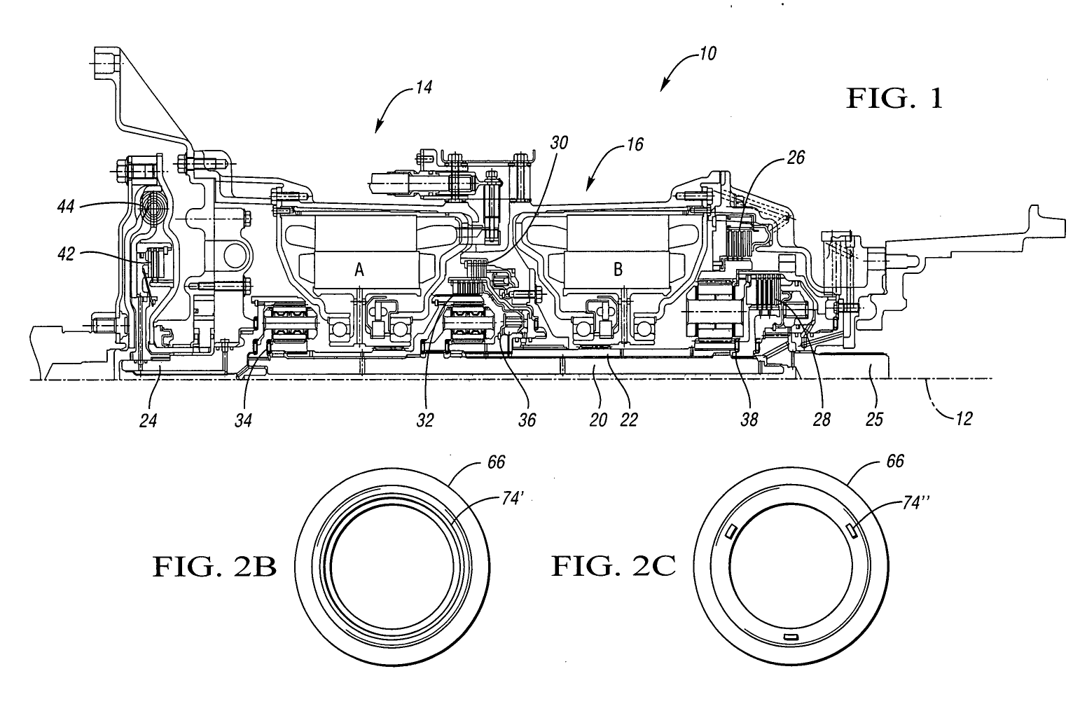

Referring to the drawings, wherein like reference numbers refer to like components, FIG. 1 shows the upper half of a transmission 10, in cross sectional view. The lower half of the transmission (not shown) is disposed on the opposite side of center axis 12. First and second electric motor modules 14, 16, respectively, are disposed about the center axis 12 within the transmission 10. A main shaft 20 is longitudinally disposed, rotatable about the center axis 12. A plurality of inner shafts, such as inner shaft 22, are concentrically disposed about the main shaft 20, and are likewise rotatable about the center axis. An input shaft 24 is disposed forward of the main shaft 20 and is operable for transferring power from an engine (not shown) to the transmission 10. An output shaft 25 is disposed rearward of the main shaft 20. Engagement of one or more of a plurality of clutches included in the transmission 10 (first, second, third and fourth clutches, 26, 28, 30 and 32 respectively, being shown) interconnects one or more of first, second and third planetary gear sets 34, 36, and 38, respectively, to transfer power at varying ratios to an output member (not shown). As will be readily understood by those skilled in the art, each of the planetary gear sets includes a sun gear member, a planet carrier assembly member and a ring gear member. A fifth clutch, referred to as a lockout clutch 42, is operable for locking out torsion isolator 44 (also referred to as damper springs) from surrounding structural elements, and to provide a direct connection between the engine and transmission.

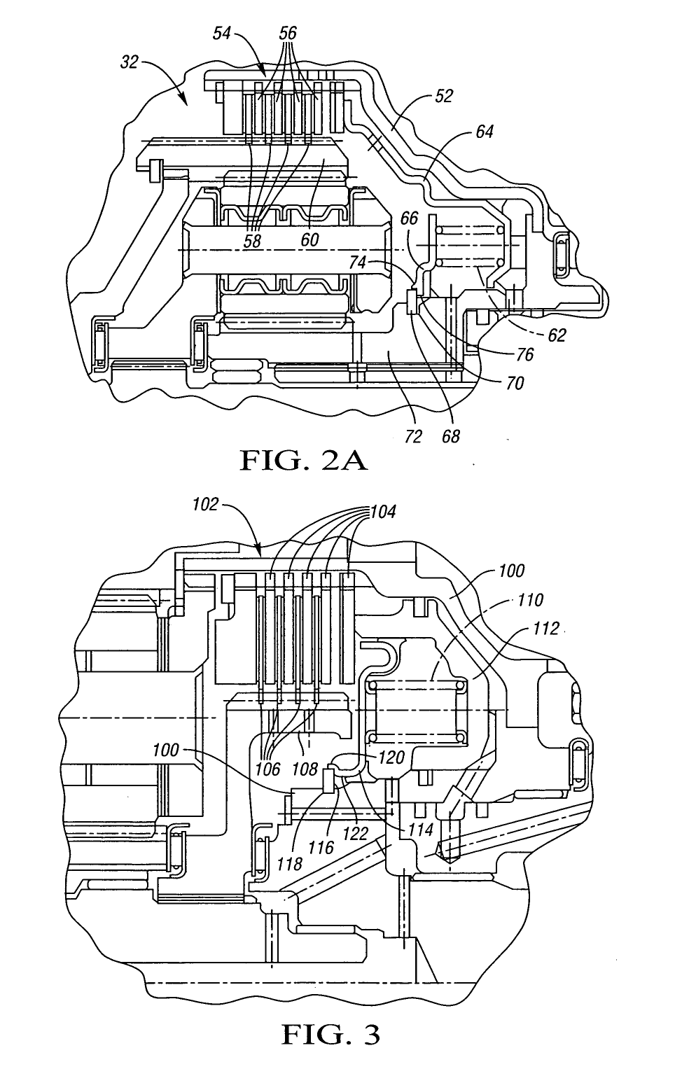

Referring to FIG. 2A, clutch 32 is shown in more detail. The clutch 32 includes a clutch housing 52 which is splined at 54 to receive a plurality of clutch plates 56. The clutch plates 56 are interposed between a plurality of friction plates 58 that are splined to a ring gear 60. The clutch plates 56 and friction plates 58 are selectively engageable by an apply piston 64. The clutch 32 further includes a piston return spring 62 disposed between the apply piston 64 and a balance piston 66. An external retaining ring 68, adapted to retain the balance piston 66 and the return spring 62, is disposed within a retainer groove 70 defined by a rotating shaft 72.

As is well known in the art, centrifugal force can cause retaining rings to expand in a radial direction and slip out of their groove. To maintain the retaining ring 68 within the groove 70, the balance piston 66 includes a shoulder portion 74 near an inner diameter 76 thereof. As shown in FIG. 2, the shoulder portion 74 prevents the retaining ring 68 from radially expanding such that the retaining ring 68 cannot slip out of the groove 70. Additionally, the balance piston 66 is biased axially into engagement with the retaining ring 68 by the return spring 62 which thereby maintains the engagement of the retaining ring 68 by the shoulder portion 74 to improve the retention of the retaining ring 68 within the groove 70. The retaining ring 68 may be disassembled by compressing the return spring 62 to axially slide the balance piston 66 away from the retaining ring 68 such that the shoulder portion 74 disengages the retaining ring 68.

According to a preferred embodiment, the shoulder portion 74 is formed with a semi-pierce operation, however, it should be appreciated that the shoulder portion 74 may also be formed according to any currently known manufacturing methods. According to a preferred embodiment, the shoulder portion 74 may define a single continuous shoulder 74′ (shown in FIG. 2B) adapted to retain the entire periphery of the retaining ring 68. Alternately, the shoulder portion 74 may include a plurality of localized tabs 74″ (shown in FIG. 2C) adapted to retain the periphery of the retaining ring 68 at discrete locations.

Referring to FIG. 3, clutch 28 is shown in more detail. The clutch 28 includes a clutch housing 100 which is splined at 102 to receive a plurality of clutch plates 104. The clutch plates 104 are interposed between a plurality of friction plates 106 that are splined to a clutch hub 108. The clutch plates 104 and friction plates 106 are selectively engageable by an apply piston 112. The clutch 28 further includes a piston return spring 110 disposed between the apply piston 112 and a balance piston 114. An external retaining ring 116, adapted to retain the balance piston 114 and the return spring 110, is disposed within a retainer groove 118 defined by clutch housing 100.

To maintain the retaining ring 116 within the groove 118, the balance piston 114 includes a shoulder portion 120 near an inner diameter 122 thereof. As shown in FIG. 3, the shoulder portion 120 prevents the retaining ring 116 from radially expanding such that the retaining ring 116 cannot slip out of the groove 118. Additionally, the balance piston 114 is biased axially into engagement with the retaining ring 116 by the return spring 110 which thereby maintains the engagement of the retaining ring 116 by the shoulder portion 120 to improve the retention of the retaining ring 116 within the groove 118. The retaining ring 116 may be disassembled by compressing the return spring 110 to axially slide the balance piston 114 away from the retaining ring 116 such that the shoulder portion 120 disengages the retaining ring 116. According to a preferred embodiment, the shoulder portion 120 is created by a forming operation; however, it should be appreciated that the shoulder portion 74 may also be created according to any currently known manufacturing methods.

While the best modes for carrying out the invention have been described in detail, those familiar with the art to which this invention relates will recognize various alternative designs and embodiments for practicing the invention within the scope of the appended claims.

1. A clutch comprising:
a plurality of clutch plates;
a plurality of friction plates being interposed between said plurality of clutch plates;
an apply piston adapted to engage the clutch plates and the friction plates;
a balance piston having a shoulder portion, wherein a return spring is contained between said balance piston and said apply piston; and
a retaining ring disposed in a retainer groove defined by a rotating member, said retaining ring being adapted to engage the balance piston wherein the retaining ring is radially retained by the shoulder portion such that the retaining ring cannot expand and slip out of the retainer groove.

2. The clutch of claim 1, wherein said shoulder portion includes a single continuous feature adapted to retain the entire periphery of the retaining ring.

3. The clutch of claim 1, wherein said shoulder portion includes a plurality of localized tabs adapted to retain the periphery of the retaining ring at discrete locations.

4. The clutch of claim 1, wherein said shoulder portion of the balance piston is created by a semi-pierce operation.

5. The clutch of claim 1, wherein said shoulder portion of the balance piston is created by a forming operation.

6. The clutch of claim 1, wherein the return spring is adapted to axially bias the balance piston into engagement with the retaining ring to maintain the engagement of the retaining ring by the shoulder portion, and to bias the apply piston in a non-applied direction.

7. A clutch comprising:
a clutch housing having a plurality of housing splines;
a plurality of clutch plates disposed within said housing splines;
a clutch hub having a plurality of hub splines;
a plurality of friction plates disposed within said hub splines, said plurality of friction plates being interposed between said plurality of clutch plates;
an apply piston adapted to frictionally engage the clutch plates and the friction plates;
a balance piston having a shoulder portion;
a retaining ring disposed in a retainer groove defined by a rotating member, said retaining ring being adapted to engage the balance piston wherein the retaining ring is radially retained by the shoulder portion such that the retaining ring cannot expand and slip out of the retainer groove; and
a return spring disposed between the apply piston and the balance piston wherein the return spring is adapted to axially bias the balance piston into engagement with the retaining ring to maintain the engagement of the retaining ring by the shoulder portion.

8. The clutch of claim 7, wherein said shoulder portion includes a single continuous feature adapted to retain the entire periphery of the retaining ring.

9. The clutch of claim 7, wherein said shoulder portion includes a plurality of localized tabs adapted to retain the periphery of the retaining ring at discrete locations.

10. The clutch of claim 7, wherein said shoulder portion of the balance piston is created by a semi-pierce operation.

11. The clutch of claim 7, wherein said shoulder portion of the balance piston is created by a forming operation.

12. A retaining apparatus for a transmission comprising:
an input shaft operatively connectable to an engine output member for rotation therewith;
an output shaft;
a geartrain configured to selectively operatively interconnect the input shaft and the output shaft, said geartrain including
a plurality of clutch plates;
a plurality of friction plates being interposed between said plurality of clutch plates;
an apply piston adapted to engage the clutch plates and the friction plates;
a balance piston having a shoulder portion, wherein a return spring is contained between said balance piston and said apply piston; and
a retaining ring disposed in a retainer groove defined by a rotating member, said retaining ring being adapted to retain the balance piston wherein the retaining ring is radially retained by the shoulder portion such that the retaining ring cannot expand and slip out of the retainer groove; and
first and second motor/generators operatively connected to the geartrain to apply power thereto or receive power therefrom.

13. The clutch of claim 12, wherein said shoulder portion includes a single continuous feature adapted to retain the entire periphery of the retaining ring.

14. The clutch of claim 12, wherein said shoulder portion includes a plurality of localized tabs adapted to retain the periphery of the retaining ring at discrete locations.

15. The clutch of claim 12, wherein said shoulder portion of the balance piston is created by a semi-pierce operation.

16. The clutch of claim 12, wherein said shoulder portion of the balance piston is created by a forming operation.
